(19) United States
(12) Patent Application Publication
(10) Pub. No.: US 2009/0087369 A1
(43) Pub. Date: Apr. 2, 2009

(54) FLUOROAPATITE DRIED PARTICLES AND ADSORPTION APPARATUS

(75) Inventors: Tsuyoshi ISHIKAWA, Tochigi (JP); Yoshiyuki OGAWARA, Tochigi (JP); Tomohiko YOSHITAKE, Tokyo (JP); Yukiko MURAKAMI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/240,152

(22) Filed: Sep. 29, 2008

(30) Foreign Application Priority Data
Oct. 1, 2007 (JP) 2007-257674

(51) Int. Cl. C01B 25/32

(52) U.S. Cl. 423/311

(57) ABSTRACT

Fluoroapatite dried particles are obtained by reacting hydroxyapatite primary particles having hydroxyl groups and hydrogen fluoride molecules having fluorine atoms so that at least one of hydroxyl groups of hydroxyapatite primary particles are substituted by the fluorine atoms of the hydrogen fluoride molecules. The fluoroapatite dried particles can exhibit superior acid resistance. Further, an adsorption apparatus using such fluoroapatite dried particles is provided.

### FIELD OF THE INVENTION

The present invention relates to fluoroapatite dried particles and an adsorption apparatus, and in particular relates to fluoroapatite dried particles and an adsorption apparatus that uses the fluoroapatite dried particles.

### BACKGROUND ART

Fluoroapatite has almost the same crystalline structure as hydroxyapatite, and therefore shows almost the same adsorption characteristics (adsorption ability) to proteins as hydroxyapatite.

Further, fluoroapatite is a substance that is stabler than hydroxyapatite, and therefore has high acid resistance. For these reasons, fluoroapatite has advantages that it has high resistance to acid solutions, and therefore is capable of separating a protein in an acid solution.

Such fluoroapatite is generally synthesized by adding (mixing) ammonium fluoride as a fluorine source into (with) a slurry containing hydroxyapatite (JP A-2004-330113 is an example of related art.).

However, in the fluoroapatite synthesized by such a method, ammonia which is derived from the ammonium fluoride is adsorbed thereto as an impurity during the synthesizing process. Apatites such as fluoroapatite have a high ability to adsorb ammonia, and therefore in a case where a slurry containing synthesized fluoroapatite is spray-dried (granulated) to obtain particles, ammonia remains in the particles (fluoroapatite particles) because it is very difficult to remove ammonia from the fluoroapatite particles.

Therefore, an amount of ammonia remaining in the thus synthesized fluoroapatite particles is different from lot to lot, which makes it difficult to obtain fluoroapatite particles having uniform characteristics.

Further, sufficient bonding strength between a fluorine atom and fluoroapatite can not obtain due to ammonia remaining in fluoroapatite (particles), and therefore there are also problems that fluorine atoms are separated from fluoroapatite and therefore it cannot be expected that acid resistance of fluoroapatite is further improved.

Furthermore, since fluoropatite is often used for separating a protein in a acid solution, it is preferred that an amount of the protein to be adsorbed to fluoroapatite is large so that a large amount of protein can be separated from a sample (that is, the acid solution containing the protein). From this viewpoint, fluoroapatite having a large specific surface area is preferably used.

For these reasons, fluoroapatite which has property of separating fluorine atoms at a low level and superior acid resistance can be preferably used for separating a protein. Further, fluoroapatite having a large specific surface area can be preferably used for separating the protein.

It is one object of the present invention to provide fluoroapatite dried particles prevented fluorine atoms from separating by reducing an impurity, such as ammonia, derived from a raw material to a low or very low level, thereby improving acid resistance thereof. Further, it is the other object of the present invention to provide an adsorption apparatus provided with an adsorbent which contains the fluoroapatite dried particles or fluoroapatite sintered particles obtained by sintering the fluoroapatite dried particles.

These objects are achieved by the present inventions (1) to (8) described below.

(1) Fluoroapatite dried particles which are obtained by reacting hydroxyapatite primary particles having hydroxyl groups and hydrogen fluoride molecules having fluorine atoms so that at least one of the hydroxyl groups of the hydroxyapatite primary particles are substituted by the fluorine atoms of the hydrogen fluoride molecules, wherein when the fluoroapatite dried particles of which average particle size is 40 μm±5 μm are classified to obtain 2 g thereof, the 2 g of the classified fluoroapatite dried particles is mixed with 20 mL of pure water to obtain a mixture, and the classified fluoroapatite dried particles are allowed to settle down in the mixture to obtain a supernatant liquid in which a fluorine ion may be contained, a concentration of the fluorine ion contained in the supernatant liquid is 12 ppm or less.

Since the fluoroapatite dried particles are produced by reducing an impurity, such as ammonia, derived from a raw material to a low or very low level, it is possible to prevent the fluorine atoms from separating. As a result, the concentration of the fluorine ion contained in the supernatant liquid is 12 ppm or less, and therefore the fluoroapatite dried particles have superior acid resistance.

(2) In the method described in the above-mentioned item (1), the settling of the classified fluoroapatite dried particles in the mixture is carried out by subjecting the mixture to a stirring treatment and an ultrasonic treatment, and then subjecting the mixture to a centrifugation treatment to obtain the supernatant liquid.

This makes it possible to reliably measure a concentration of the fluorine atoms separated from the fluoroapatite dried particles into the supernatant liquid as the concentration of the fluorine ion.

(3) In the method described in the above-mentioned item (1), a specific surface area of the fluoroapatite dried particles is 30 m²/g or larger.

The fluoroapatite dried particles having such a specific surface area can separate a large amount of a protein.

Generally, a specific surface area of fluoroapatite sintered particles tends to become small by setting a high sintering temperature and a long sintering time of obtaining the fluoroapatite sintered particles from fluoroapatite dried particles. However, since the specific surface area of the fluoroapatite dried particles is large, the present invention has an advantage that fluoroapatite sintered particles having a predetermined specific surface area can be obtained by appropriately setting the sintering conditions such as the sintering temperature and the sintering time of obtaining the fluoroapatite sintered particles from the fluoroapatite dried particles.

(4) In the method described in the above-mentioned item (1), an average particle size of the fluoroapatite dried particles is in the range of 30 to 50 μm.

The fluoroapatite having such an average particle size which falls within the above mention range can be reliably used as an adsorbent of an adsorption apparatus. Further, the fluoroapatite sintered particles obtained by sintering the fluoroapatite dried particles can be also used as the adsorbent of the adsorption apparatus.

(5) In the method described in the above-mentioned item (1), the hydrogen fluoride molecules are contained in a hydrogen fluoride-containing solution, the hydroxyapatite primary particles are contained in a slurry, and the hydrogen fluoride-containing solution is mixed with the slurry to obtain a dispersion liquid, wherein the reacting the hydroxyapatite primary particles and the hydrogen fluoride molecules is carried out in the dispersion liquid.

In the case where the fluoroapatite dried particles of which average particle size is 40 μm±5 μm are classified to obtain 2 g thereof, and the 2 g of the classified fluoroapatite dried particles is mixed with 20 mL of pure water to obtain a mixture, it is possible to reliably set the concentration of the fluorine ion contained in the supernatant liquid with the concentration described above.

(6) In the method described in the above-mentioned item (5), a pH of the dispersion liquid is in the range of 2.5 to 5.0.

This makes it possible to reliably set the concentration of the fluorine ion contained in the supernatant liquid within the concentration described above.

(7) In the method described in the above-mentioned item (5), the hydroxyapatite primary particles are synthesized from a calcium compound and a phosphate compound by using a wet synthesis method, wherein at least one of the calcium compound and the phosphate compound is contained in a solution to provide the slurry in the wet synthesis method.

By using such a wet synthesis method, it is possible to form fine hydroxyapatite primary particles and obtain a slurry in which aggregates of the fine hydroxyapatite primary particles (hydroxyapatite secondary particles) are dispersed uniformly.

(8) An adsorbent is comprised of the fluoroapatite dried particles defined in claim 1 or fluoroapatite sintered particles obtained by sintering the fluoroapatite dried particles.

This makes it possible to provide the adsorption apparatus provided with the adsorbent having high acid resistance.

According to the present invention, since hydrogen fluoride is used as a fluorine source when at least one of hydroxyl groups of hydroxyapatite is substituted by fluorine atoms of the hydrogen fluoride molecules in the present invention, the fluoroapatite dried particles in which no impurity is contained or an impurity is contained at very low level are obtained. Therefore, when the fluoroapatite dried particles of which average particle size is 40 μm±5 μm are classified to obtain 2 g thereof, the 2 g of the classified fluoroapatite dried particles is mixed with 20 mL of pure water to obtain a mixture, and the classified fluoroapatite dried particles are allowed to settle down in the mixture to obtain a supernatant liquid containing a fluorine ion, a concentration of the fluorine ion contained in the supernatant liquid is 12 ppm or less. As a result, the fluoroapatite dried particles can exhibit superior acid resistance.

### BRIEF DESCRIPTION OF THE DRAWINGS

FIG. 1 is powder X-ray diffraction patterns of fluoroapatite sintered particles sintered at a temperature of 400° C. in Example and Comparative Example.

FIG. 2 is a graph which shows a change in protein separation characteristics in a column filled with fluoroapatite sintered particles sintered at a temperature of 400° C. in Example.

FIG. 3 is a graph which shows a change in protein separation characteristics in a column filled with fluoroapatite sintered particles sintered at a temperature of 400° C. in Comparative Example.

FIG. 4 is a calibration curve which shows a relationship between an electric potential of a solution and a concentration of a fluorine ion contained in the solution.

### BEST MODE FOR CARRYING OUT THE INVENTION

Hereinbelow, fluoroapatite dried particles and an adsorption apparatus according to the present invention will be described in detail with reference to their preferred embodiments.

The present invention is fluoroapatite dried particles in which at least one of hydroxyl groups of hydroxyapatite is substituted by fluorine atoms of hydrogen fluoride molecules.

In other words, the fluoroapatiote dried particles of present invention is represented by the following composition formula (I). The fluorine atoms in the composition formula (I) are derived from the hydrogen fluoride molecules.

Ca₁₀(PO₄)₆(OH)₂₋₂ₓF₂ₓ (I)

(wherein 0<x≦1)

The fluoroapatite dried particles of the present invention are obtained by substituting the hydroxyl groups of hydroxyapatite by the fluorine atoms of the hydrogen fluoride molecules. Therefore, it is possible to reliably prevent an impurity such as ammonia from being mixed into the fluoroapatite dried particles compare to a method using ammonium fluoride as a fluorine source. For these reasons, when the fluoroapatite dried particles of which average particle size is 40 μm±5 μm are classified to obtain 2 g thereof, the 2 g of the classified fluoroapatite dried particles is mixed with pure water of 20 mL to obtain a mixture, and the classified fluoroapatite dried particles are allowed to settle down in the mixture to obtain a supernatant liquid containing a fluorine ion, a concentration of the fluorine ion contained in the supernatant liquid is 12 ppm or less. In this way, the fluoroapatite dried particles of which separation of the fluorine atoms is prevented have high crystallinity. Therefore, the fluoroapatite dried particles have improved acid resistance.

A concentration of a fluorine ion contained in the supernatant liquid, namely a concentration of the fluorine atoms separated from the fluoroapatite dried particles to the supernatant liquid may be preferably 12 ppm or less and more preferably as low as possible, i.e., as close to “0 ppm” as possible. More specifically, the concentration of the fluorine ion (fluorine atoms) is preferably 10 ppm or less and more preferably 6 ppm or less. Therefore, the fluoroapatite dried particles have improved acid resistance.

Classifying the fluoroapatite dried particles mixed with pure water so as to fall within a predetermined range of the average particle size is the reason that an amount of the fluorine atoms separated from the fluoroapatite dried particles to the supernatant liquid depends on particle sizes of the mixed fluoroapatite dried particles.

Further, in the present invention, falling the average particle size within the range of 40±5 μm is the reason that the fluoroapatite dried particles of which average particle size is in the range of 30 to 100 μm (preferably in the range of 30 to 50 μm) and the fluoroapatite sintered particles which are obtained by sintering the fluoroapatite dried particles are preferably and appropriately used as an adsorbent of an adsorption apparatus as described later.

It is preferred that the supernatant liquid is obtained as follows. That is to say, a mixture of pure water and fluoroapatite dried particles is subjected to a stirring treatment and an ultrasonic treatment. Then, the mixture is subjected to a centrifugation treatment to obtain the supernatant liquid. This makes it possible to reliably measure a concentration of fluorine atoms separated from the fluoroapatite dried particles into the supernatant liquid as a concentration of a fluorine ion.

The order of the stirring treatment and the ultrasonic treatment to the mixture is not particularly limited but it is preferred that the stirring treatment is carried out before and after the ultrasonic treatment. This makes it possible to reliably dissolve the fluorine atoms separated from the fluoroapatite dried particles into the pure water.

A time of the stirring treatment before the ultrasonic treatment is preferably in the range of about 5 to 15 minutes and more preferably about 10 minutes. A time of the stirring treatment after the ultrasonic treatment is preferably in the range of about 0.5 to 10 minutes and more preferably about 1 minute. A time of the ultrasonic treatment is preferably in the range of about 1 to 10 minutes and more preferably about 5 minutes.

Conditions of subjecting the mixture to the centrifugation treatment are as follows. A rotation speed of the mixture is preferably in the range of about 1000 to 3000 rpm and more preferably about 2000 rpm. A time of the centrifugation treatment is preferably in the range of about 5 to 15 minutes and more preferably about 10 minutes.

A specific surface area of the fluoroapatite (dried particles) in which hydroxyl groups of hydroxyapatite is substituted by the fluorine atoms of the hydrogen fluoride molecules is sufficiently large for separating a large amount of a protein.

A specific surface area of the fluoroapatite dried particles which are granulated by using fluoroapatite primary particles obtained by such a method is preferably 30.0 m²/g or larger and more preferably 35.0 m²/g or larger. Such a specific surface area of the fluoroapatite dried particles is sufficiently large for separating a large amount of a protein.

Further, a specific surface area of fluoroapatite sintered particles which are obtained by sintering the fluoroapatite dried particles normally tends to become small by setting to a high temperature or long time of sintering the fluoroapatite dried particles. However, if the specific surface area of the fluoroapatite dried particles is large, there is an advantage that the fluoroapatite sintered particles having a predetermined specific surface area can be obtained by setting sintering conditions such as a temperature and a time when the fluoroapatite sintered particles are obtained from the fluoroapatite dried particles.

Fluoroapatite dried particles of the present invention as described above is produced from hydroxyapatite and hydrogen fluoride molecules by a method of producing fluoroapatite as described below.

The method of producing fluoroapatite according to the present embodiment includes a slurry preparation step (S1), a hydrogen fluoride-containing solution preparation step (S2), and a fluoroapatite synthesis step (S3). Hereinbelow, these steps will be described in order.

<S1> Slurry Preparation Step

First, a slurry containing hydroxyapatite is prepared.

Hereinbelow, a method of preparing hydroxyapatite primary particles and a slurry in which aggregates of the hydroxyapatite primary particles are dispersed will be described.

The hydroxyapatite primary particles can be obtained by various synthesis methods, but are preferably synthesized by a wet synthesis method in which at least one of a calcium source (calcium compound) and a phosphoric acid source (phosphoric acid compound) is used in the form of a solution. By using such a wet synthesis method, it is possible to form fine hydroxyapatite primary particles and thereby to obtain the slurry in which the aggregates of the fine hydroxyapatite primary particles are uniformly dispersed.

Further, such a wet synthesis method does not need expensive production equipment, and makes it possible to simply prepare the slurry and efficiently synthesize hydroxyapatite to produce the hydroxyapatite primary particles.

Further, the thus produced hydroxyapatite primary particles are small in size, and have therefore very highly reactive with hydrogen fluoride in the step S3 which will be described later. As a result, the fluoroapatite primary particles having a high rate of substitution of hydroxyl groups of hydroxyapatite by fluorine atoms of hydrogen fluoride molecules are obtained.

Examples of the calcium source to be used in the wet synthesis of the present embodiment include calcium hydroxide, calcium oxide, calcium nitrate and the like. Examples of the phosphoric acid source to be used in the wet synthesis of the present invention include phosphoric acid, ammonium phosphate and the like. Among them, one mainly containing calcium hydroxide or calcium oxide is particularly preferred as the calcium source, and one mainly containing phosphoric acid is particularly preferred as the phosphoric acid source.

By using such calcium source and phosphoric acid source, it is possible to more efficiently and cheaply produce the hydroxyapatite primary particles. Further, it is also possible to easily obtain the slurry in which the hydroxyapatite primary particles or their aggregates are dispersed.

More specifically, such hydroxyapatite primary particles and a slurry can be obtained by dropping a phosphoric acid (H₃PO₄) solution into a suspension of calcium hydroxide (Ca(OH)₂) or calcium oxide (CaO) contained in a container and mixing them by stirring.

An average particle size of the aggregates of such hydroxyapatite primary particles is preferably in the range of about 1 to 20 μm, and more preferably in the range of about 5 to 12 μm. This makes it possible to effectively prevent handling of the aggregates from becoming difficult due to too small size thereof. The average particle size of these aggregates is an appropriately size, and therefore can be easily brought into contact with hydrogen fluoride so that the hydroxyl groups of hydroxyapatite are more efficiently substituted by the fluorine atoms of the hydrogen fluoride molecules.

An amount of the hydroxyapatite primary particles contained in the slurry is preferably in the range of about 1 to 20 wt %, and more preferably in the range of about 5 to 12 wt %. This makes it possible to more efficiently substitute the hydroxyl groups of hydroxyapatite by the fluorine atoms of the hydrogen fluoride molecules in the step S3 which will be described later. In addition, it is also possible to sufficiently stir the slurry with relatively low energy in the step S3 and thereby to make an uniform rate of substitution of the hydroxyl groups of hydroxyapatite by the fluorine atoms of the hydrogen fluoride molecules among the hydroxyapatite primary particles.

<S2> Hydrogen Fluoride-Containing Solution Preparation Step

A solution containing hydrogen fluoride is prepared separately from the slurry containing hydroxyapatite.

A solvent for dissolving hydrogen fluoride is not particularly limited, and any solvent can be used as long as it does not inhibit a reaction to be carried out in the step S3 which will be described later.

Examples of such a solvent include water, an alcohol such as methanol and ethanol, and the like. These solvents may be used in combination of two or more of them. However, among them, water is particularly preferred. By using water as a solvent, it is possible to more reliably prevent the inhibition of the reaction to be carried out in the step S3 which will be described later.

An amount of hydrogen fluoride contained in the hydrogen fluoride-containing solution is preferably in the range of about 1 to 60 wt %, and more preferably in the range of about 2.5 to 10 wt %. By setting the amount of hydrogen fluoride contained in the hydrogen fluoride-containing solution to a value within the above range, it is possible to easily adjust a pH of the slurry in which the hydrogen fluoride-containing solution is added to a value within a desired range in the step S3. In addition, it is also possible to prevent the hydrogen fluoride-containing solution from reaching an extremely low pH and thereby to handle the hydrogen fluoride-containing solution safely.

<S3> Fluoroapatite Synthesis Step

Then, the slurry prepared in the step S1 and the hydrogen fluoride-containing solution prepared in the step S2 are mixed together to react the hydroxyapatite primary particles with hydrogen fluoride in the slurry containing the hydrogen fluoride-containing solution to obtain fluoroapatite primary particles.

More specifically, as shown in the following formula (II), by bringing the hydroxyapatite primary particles into contact with hydrogen fluoride, it is possible to substitute at least part of the hydroxyl groups of the hydroxyapatite by the fluorine atom of the hydrogen fluoride molecules to convert hydroxyapatite into fluoroapatite and thereby to obtain the fluoroapatite primary particles.

Ca₁₀(PO₄)₆(OH)₂→Ca₁₀(PO₄)₆(OH)₂₋₂ₓF₂ₓ (II)

(wherein 0<x≦1)

As described above, by reacting the hydroxyapatite primary particles with hydrogen fluoride in the slurry containing the hydroxyapatite primary particles, it is possible to easily produce the fluoroapatite primary particles.

Further, since the hydroxyl groups of hydroxyapatite are substituted by the fluorine atoms of the hydrogen fluoride molecules during the stage of the hydroxyapatite primary particles, the obtained fluoroapatite primary particles have a particularly high rate of substitution of the hydroxyl groups by the fluorine atoms.

Further, since hydrogen fluoride (HF) is used as a fluorine source, no by-product is formed or an amount of a formed by-product is extremely small as compared to a case where ammonium fluoride (NH₄F), lithium fluoride (LiF), sodium fluoride (NaF), potassium fluoride (KF), magnesium fluoride (MgF₂), calcium fluoride (CaF₂), or the like is used as the fluorine source. Therefore, an amount of an impurity (by-product) contained in the fluoroapatite primary particles can be made small so that acid resistance of the fluoroapatite primary particles is improved. It is to be noted that the term “impurity” used herein means ammonia, lithium or the like derived from a raw material of fluoroapatite.

More specifically, the impurity content of fluoroapatite (primary particles) is preferably as small as possible. For example, it is preferably 300 ppm or less, and more preferably 100 ppm or less. This makes it possible to further suppress the fluorine atoms from separating from the fluoroapatite primary particles due to their low impurity content. As a result, it is also possible to improve acid resistance of the fluoroapatite primary particles.

According to the present embodiment, by adjusting the reaction conditions (e.g., pH, temperature, time) of the reaction between hydroxyapatite (primary particles) and hydrogen fluoride, it is possible to allow the impurity content contained in the fluoroapatite primary particles to fall within the above range. Further, it is also possible to allow the fluorine ion (free fluorine ion) contained in a supernatant liquid to fall within the above range.

Particularly, according to the present embodiment, a pH of the slurry is adjusted to preferably fall within the range of about 2.5 to 5 and more preferably fall within the range of about 2.7 to 4 by mixing the hydrogen fluoride-containing solution with the slurry, and in this state, the hydroxyapatite (primary particles) reacts with hydrogen fluoride. This makes it possible to allow the impurity content contained in the fluoroapatite primary particles and to fall the free fluorine ion contained in the supernatant liquid within the above range. In this regard, it is to be noted that in this specification, the pH of the slurry means a pH value at the time when an entire amount of the hydrogen fluoride-containing solution is mixed with the slurry.

If the pH of the slurry is adjusted to less than 2.5, there is a tendency that hydroxyapatite itself dissolves, and therefore there is a fear that it becomes difficult to convert hydroxyapatite into fluoroapatite to obtain fluoroapatite primary particles. Further, in this case, there is also a problem that constituent materials of a device for use in mixing the hydroxyapatite primary particles with the hydrogen fluoride-containing solution are eluted into the slurry so that low-purity fluoroapatite primary particles are obtained. Furthermore, it is technically very difficult to adjust the pH of the slurry to a low value less than 2.5 using the hydrogen fluoride-containing solution.

On the other hand, in order to adjust the pH of the slurry to more than 5 using the hydrogen fluoride-containing solution, a large amount of water has to be added to the slurry. In this case, a total amount of the slurry becomes extremely large, and as a result, a yield of the fluoroapatite primary particles based on the total amount of the slurry is lowered. This is industrially disadvantageous.

In contrast to the above two cases, in a case where the pH of the slurry is adjusted to fall within the range of 2.5 to 5, fluoroapatite (primary particles) produced by the reaction once tends to dissolve and is then recrystallized. Therefore, the fluoroapatite primary particles having high crystallinity can be obtained.

The slurry and the hydrogen fluoride-containing solution may be mixed together at one time, but they are preferably mixed by adding (dropping) the hydrogen fluoride-containing solution into the slurry drop by drop. By dropping the hydrogen fluoride-containing solution into the slurry, it is possible to relatively easily react the hydroxyapatite primary particles with hydrogen fluoride and to more easily and reliably adjust the pH of the slurry to a value within the above range. Therefore, it is possible to prevent decomposition or dissolution of hydroxyapatite itself and thereby to obtain high-purity fluoroapatite primary particles in a good yield.

A rate of dropping the hydrogen fluoride-containing solution into the slurry is preferably in the range of about 1 to 100 L/hr, and more preferably in the range of about 3 to 100 L/hr. By mixing (adding) the hydrogen fluoride-containing solution with (to) the slurry at such a dropping rate, it is possible to react the hydroxyapatite primary particles with hydrogen fluoride under milder conditions.

Further, the reaction between the hydroxyapatite primary particles and hydrogen fluoride is preferably carried out while the slurry is stirred. By stirring the slurry, it is possible to bring the hydroxyapatite primary particles into uniform contact with hydrogen fluoride and thereby to allow the reaction between the hydroxyapatite primary particles and hydrogen fluoride to efficiently proceed. In addition, it is also possible to obtain the fluoroapatite primary particles more uniform in the rate of substitution of the hydroxyl groups of hydroxyapatite by the fluorine atoms of the hydrogen fluoride molecules. By using such fluoroapatite primary particles, it is possible to produce, for example, an adsorbent (fluoroapatite dried particles or fluoroapatite sintered particles) having less characteristic variations and high reliability.

In this case, power for stirring the slurry is preferably in the range of about 0.1 to 3 W, and more preferably in the range of about 0.5 to 1.8 W per 1 liter of the slurry. By setting the stirring power to a value within the above range, it is possible to further improve the efficiency of the reaction between the hydroxyapatite primary particles and hydrogen fluoride.

An amount of hydrogen fluoride to be mixed is determined so that an amount of the fluorine atoms becomes preferably in the range of about 0.65 to 1.25 times and more preferably in the range of about 0.75 to 1.15 times with respect to an amount of the hydroxyl groups of hydroxyapatite. This makes it possible to more efficiently substitute the hydroxyl groups of hydroxyapatite by the fluorine atoms of the hydrogen fluoride molecules.

A temperature of the reaction between the hydroxyapatite primary particles and hydrogen fluoride is not particularly limited, but is preferably in the range of about 5 to 50° C. and more preferably in the range of about 20 to 40° C. By setting the temperature to a value within the above range, it is possible to prevent decomposition or dissolution of hydroxyapatite (primary particles) even when the pH of the slurry is adjusted to a low value. Further, it is also possible to improve a reaction rate between the hydroxyapatite primary particles and hydrogen fluoride. Furthermore, it is also possible to efficiently promote recrystallization of the produced fluoroapatite and thereby to obtain the fluoroapatite primary particles.

In this case, hydrogen fluoride is preferably dropped (added) into (to) the slurry containing the hydroxyapatite primary particles for a length of time from about 30 minutes to 16 hours, and more preferably for a length of time from about 1 to 8 hours. By dropping hydrogen fluoride into the slurry containing the hydroxyapatite primary particles in such a period of time to react the hydroxyapatite primary particles with hydrogen fluoride, it is possible to sufficiently substitute the hydroxyl groups of hydroxyapatite by the fluorine atoms of the hydrogen fluoride molecules. It is to be noted that even if the time for dropping hydrogen fluoride into the slurry is prolonged to exceed the above upper limit value, it can not be expected that the reaction between the hydroxyapatite primary particles and hydrogen fluoride will further proceed.

In such a manner as described above, hydroxyapatite primary particles are reacted with the hydrogen fluoride molecules contained in a dispersion liquid in which the surly containing hydroxyapatite primary particles is mixed with the hydrogen fluoride-containing solution containing hydrogen fluoride molecules. As a result, at least a part of the hydroxyl groups of hydroxyapatite are substituted by the fluorine atoms of the hydrogen fluoride molecules so that fluoroapatite (fluoroapatite dried particles) is obtained.

In the case where the fluoroapatite dried particles of which average particle size is 40 μm±5 μm are classified to obtain 2 g thereof, the 2 g of the classified fluoroapatite dried particles is mixed with 20 mL of pure water to obtain a mixture, and the classified fluoroapatite dried particles are allowed to settle down in the mixture to obtain a supernatant liquid containing a fluorine ion, a concentration of the fluorine ion contained in the supernatant liquid can be allowed to reliably fall within the above range.

Fluoroapatite is not limited to pure fluoroapatite as shown by the formula (I) described above wherein degree of halogenation represented as x is 1 (i.e., fluoroapatite obtained by substituting all the hydroxyl groups of hydroxyapatite by the fluorine atoms of the hydrogen fluoride molecules). The fluoroapatite also includes one obtained by substituting only part of the hydroxyl groups of hydroxyapatite by the fluorine atoms of the hydrogen fluoride molecules.

Further, according to the present invention, it is possible to substitute the hydroxyl groups of hydroxyapatite present not only in the surface but also in the inside portion of the hydroxyapatite primary particles by the fluorine atoms of the hydrogen fluoride molecules. More specifically, it is possible to substitute 75% or more of the hydroxyl groups of hydroxyapatite by the fluorine atoms of the hydrogen fluoride molecules. Further, by appropriately regulating the reaction conditions (e.g., pH, temperature, time, amount of hydrogen fluoride to be mixed) of the reaction between the hydroxyapatite primary particles and hydrogen fluoride, it is also possible to substitute 95% or more of the hydroxyl groups of hydroxyapatite by the fluorine atoms of the hydrogen fluoride molecules. It is to be noted that the fluoroapatite obtained by substituting 50% or more of the hydroxyl groups of hydroxyapatite by the fluorine atoms of the hydrogen fluoride molecules is preferred because it has particularly excellent acid resistance.

Further, such fluoroapatite primary particles contain a very little amount of an impurity, are stable and are suppressed the fluorine atoms from separating, and are therefore excellent in acid resistance.

The fluoroapatite dried particles can be obtained by drying or granulating the slurry containing such fluoroapatite primary particles, and the fluoroapatite dried particles can be further sintered to obtain fluoroapatite sintered particles. In a case where the fluoroapatite is used as an adsorbent, fluoroapatite sintered particles are preferred from the viewpoint of mechanical strength. However, in a case where a load to be applied to the adsorbent is relatively light, the fluoroapatite dried particles may also be used. By using such an adsorbent as a stationary phase of an adsorption apparatus used in chromatography, it is possible to expand the range of choices of conditions for separation or adsorption of an object to be tested (e.g., protein) and thereby to apply such an adsorption apparatus used in chromatography to a wider range of areas (fields).

It is to be noted that a method of drying or granulating the slurry containing the fluoroapatite primary particles is not particularly limited, and an example of such a method includes spray drying using a spray drier and the like. Further, a temperature of the spray drying is preferably in the range of about 120 to 200° C.

A sintering temperature of the fluoroapatite dried particles is preferably in the range of about 200 to 800° C., and more preferably in the range of about 400 to 700° C. By setting the sintering temperature to a value within the above range, it is possible to obtain an adsorbent having excellent mechanical strength while gaps (pores) are allowed to remain in the fluoroapatite primary particles or between the fluoroapatite primary particles adjacent to each other (i.e., in aggregates).

The application of fluoroapatite is not limited to such an adsorbent. For example, the fluoroapatite dried particles may be molded and then sintered to obtain a sintered body. The thus obtained sintered body can be used as artificial bone or dental root.

Although the fluoroapatite dried particles and the adsorption apparatus according to the present invention have been described above with reference to their preferred embodiments, the present invention is not limited to these embodiments.

For example, the above embodiments have been described with reference to a representative case where the fluoroapatite dried particles are produced using the hydrogen fluoride-containing solution and the hydroxyapatite primary particles, but hydroxyapatite dried particles obtained by granulating the hydroxyapatite primary particles may be used instead of the hydroxyapatite primary particles. Also in this case, by substituting the hydroxyl groups of the hydroxyapatite primary particles by the fluorine atoms of the hydrogen fluoride molecules as in the case of the above embodiments, it is possible to increase a rate of substitution of the hydroxyl groups by the fluorine atoms and thereby to suppress the fluorine atoms from separating from the fluoroapatite dried particles. As a result, it is possible to obtain the fluoroapatite dried particles having excellent acid resistance.

### EXAMPLE

Hereinbelow, the present invention will be described with reference to actual examples.

1. Production of Fluoroapatite

### EXAMPLE

First, calcium hydroxide was suspended in pure water to obtain a calcium hydroxide suspension, and then an aqueous phosphoric acid solution was dropped into the calcium hydroxide suspension while the calcium hydroxide suspension was sufficiently stirred. As a result, 500 L of a slurry containing 10 wt % of hydroxyapatite primary particles was obtained.

It is to be noted that the thus obtained hydroxyapatite primary particles were found to be hydroxyapatite by powder X-ray diffractometry.

On the other hand, hydrogen fluoride was dissolved in pure water so that an amount thereof is 5 wt % to prepare a hydrogen fluoride-containing solution.

Then, 41.84 L of the hydrogen fluoride-containing solution was dropped into the slurry at a rate of 5 L/hr while the slurry was stirred at a stirring power of 0.5 kW.

It is to be noted that the slurry had a pH of 3.00 at the time when the dropping of the hydrogen fluoride-containing solution was completed. An amount of hydrogen fluoride to be mixed with the slurry was determined so that an amount of fluorine atoms of the hydrogen fluoride molecules (hydrogen fluoride) became about 1.05 times with respect to an amount of the hydroxyl groups of hydroxyapatite.

Further, the slurry was stirred at a stirring power of 0.5 kW at 30° C. for 24 hours to react the hydroxyapatite primary particles with hydrogen fluoride. As a result, a slurry containing fluoroapatite primary particles was obtained.

It is to be noted that a reaction product contained in the slurry, namely the fluoroapatite primary particles were found to be fluoroapatite by powder X-ray diffractometry. Further, as a result of powder x-ray diffraction of the fluoroapatite primary particles, a rate of substitution of the hydroxyl groups by the fluorine atoms of the hydrogen fluoride molecules was found to be about 100%.

Further, as a result of powder X-ray diffraction of dried particles of the fluoroapatite, any products other than fluoroapatite were not detected.

Then, the slurry containing the fluoroapatite primary particles was spray-dried at 150° C. using a spray drier (manufactured by OHKAWARA KAKOHKI Co., Ltd. under the trade name of “OC-20”) to produce particulate dried particles (hereinafter, referred to as “fluoroapatite dried particles”.).

Then, part of the fluoroapatite dried particles were classified to obtain particles having a median particle size of about 40 μm, and then these particles were sintered in an electric furnace at 400° C. for 4 hours to obtain fluoroapatite sintered particles 1. Also, part of the fluoroapatite dried particles were classified to obtain particle having a median particle size of about 40 μm, and then these particles were sintered in an electric furnace at 700° C. for 4 hours to obtain fluoroapatite sintered particles 2.

It is to be noted that each of the two kinds of fluoroapatite sintered particles 1 and 2 (adsorbents) had an average particle size of about 40 μm.

### COMPARATIVE EXAMPLE

First, a slurry containing 10 wt % of hydroxyapatite primary particles was prepared in the same manner as in the Example.

Then, 4.5 L of a 6 M aqueous ammonium fluoride solution was dropped into 20 L of the slurry at a rate of 1.2 L/hr while the slurry was stirred at a stirring power of 22 W.

It is to be noted that a pH of the slurry at the time of completion of the dropping of the aqueous ammonium fluoride solution was 7.00.

Further, the slurry was stirred at a stirring power of 22 W at 30° C. for 24 hours to react the hydroxyapatite primary particles and ammonium fluoride. As a result, a slurry containing fluoroapatite primary particles was obtained.

It is to be noted that a reaction product contained in the slurry, namely the fluoroapatite primary particles were found to be fluoroapatite by powder X-ray diffractometry. Further, as a result of powder X-ray diffraction of the fluoroapatite primary particles, a rate of substitution of the hydroxyl groups by the fluorine atoms was about 70%.

Then, the slurry containing the fluoroapatite primary particles was spray-dried at 150° C. using the same spray drier as used in the Example to produce particulate dried particles (hereinafter, referred to as “fluoroapatite dried particles”.).

Then, part of the fluoroapatite dried particles were classified to obtain particles having a median particle size of about 40 μm, and then these particles were sintered in an electric furnace at 400° C. for 4 hours to obtain fluoroapatite sintered particles 1. Also, part of the fluoroapatite dried particles were classified to obtain particles having a median particle size of about 40 μm, and then these particles were sintered in an electric furnace at 700° C. for 4 hours to obtain fluoroapatite sintered particles 2.

It is to be noted that each of the two kinds of fluoroapatite sintered particles 1 and 2 (adsorbents) had an average particle size of about 40 μm.

Further, each of the three kinds of fluoroapatite particles (i.e., the fluoroapatite dried particles obtained by spray drying after synthesis of the fluoroapatite, the fluoroapatite sintered particles 1 obtained by sintered the fluoroapatite dried particles at 400° C. and the fluoroapatite sintered particles 2 obtained by sintered the fluoroapatite dried particles at 700° C.) was washed with pure water three times, and was then left standing for one day to obtain a supernatant liquid. Then, Nessler's reagent was added to the thus obtained two kinds of supernatant liquids, and as a result, both of them turned brown. From the results, it can be considered that part of ammonia was separated from the fluoroapatite primary particles. On the other hand, the fluoroapatite dried particles and the fluoroapatite sintered particles 1, 2, which are obtained in the Example, were also treated in the same manner as described above to obtain supernatant liquids, and then Nessler's reagent was added to the supernatant liquids, but none of them turned brown.

### REFERENCE EXAMPLE

A slurry containing hydroxyapatite primary particles was obtained in the same manner as in the Example.

Then, the slurry containing the hydroxyapatite primary particles was spray-dried at 150° C. using the same spray drier as used in the Example to produce particulate dried particles (hereinafter, referred to as “hydroxyapatite dried particles”.).

Then, part of the hydroxyapatite dried particles were classified to obtain particles having a median particle size of about 40 μm, and then these particles were sintered in an electric furnace at 400° C. for 4 hours to obtain hydroxyapatite sintered particles 1.

It is to be noted that the obtained hydroxyapatite sintered particles 1 (adsorbents) had an average particle size of about 40 μm.

2. Evaluation

2-1. Evaluation of Crystallinity by Powder X-Ray Diffraction

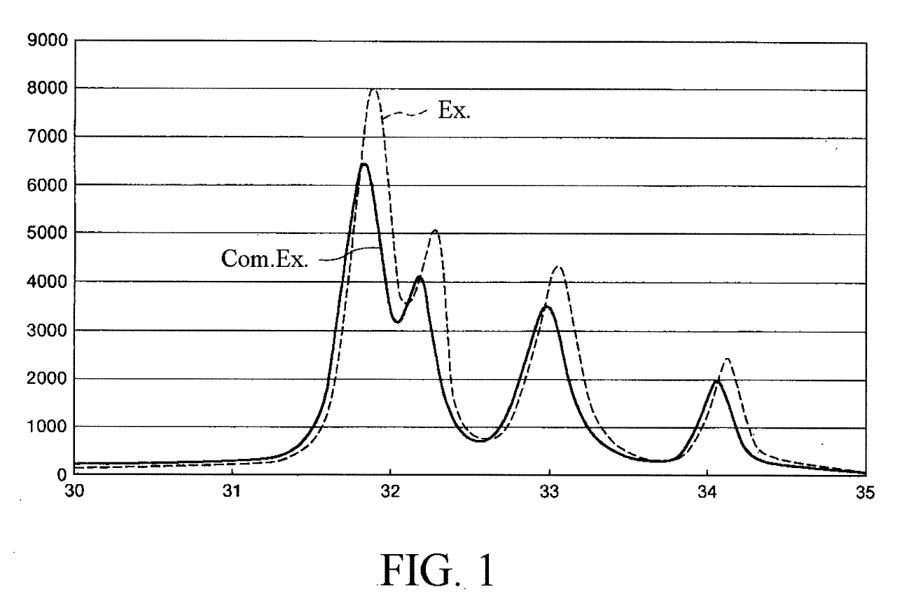

Each of the fluoroapatite sintered particles 1 obtained in the Example and the Comparative Example were subjected to powder X-ray diffraction to obtain a pattern having peaks containing a main peak as shown in FIG. 1.

As a result, from the number of counts in the main peak, etc., it has been found that the fluoroapatite sintered particles 1 of the Example have high crystallinity, whereas the fluoroapatite sintered particles 1 of the Comparative Example have low crystallinity.

2-1. Evaluation of Specific Surface Area

Each of the fluoroapatite dried particles and the fluoroapatite sintered particles 1 obtained in the Example and the Comparative Example was subjected to an automatic specific surface area analyzer (“Macdel model-1201” produced by Mountech Co., Ltd) to obtain a specific surface area thereof.

The results are shown in Table 1.

As shown in FIG. 1, there was a tendency that a specific surface area of each of the fluoroapatite dried particles and the fluoroapatite sintered particles 1 obtained in the Example and the Comparative Example became small threreamong as compared to that obtained in the Reference Example. However, it is found that the specific surface area was a sufficient size for separating a large amount of a protein.

2-3. Evaluation of Particle Breaking Strength

Each of the fluoroapatite dried particles and the fluoroapatite sintered particles 1 obtained in the Example and the Comparative Example was subjected to a compression testing machine (“MCT-W200-J” produced by Shimadzu Corporation) to obtain a particle breaking strength thereof.

The results are shown in Table 1.

As shown in FIG. 1, there was a tendency that a particle breaking strength of each of the fluoroapatite dried particles and the fluoroapatite sintered particles 1 obtained in the Example and the Comparative Example became large among the fluoroapatite dried particles and the fluoroapatite sintered particles 1 as compared to that obtained in the Reference Example. Therefore, it is found that the particle breaking strength of each of the fluoroapatite dried particles and the fluoroapatite sintered particles 1 obtained in the Example and the Comparative Example was excellent.

Despite the fluoroapatite dried particles of the Example were not sintered, the particle breaking strength of the fluoroapatite dried particles was larger than that of the fluoroapatite sintered particles of the Reference Example which were used as a adsorbent used in a general chromatography.

2-4. Evaluation of Free Fluorine-Ion Concentration

Each of the fluoroapatite dried particles and the fluoroapatite sintered particles 1 obtained in the Example and the Comparative Example was weighed 2 g thereof. Thereafter, each 2 g thereof was mixed with pure water of 20 mL to obtain a mixture.

Next, the mixture was stirred by a rotator for ten minutes. Then, the mixture was dispersed by an ultrasonic washing machine for five minutes, and then was again stirred by the rotator for one minute. Thereafter, the mixture was subjected to a centrifugation treatment under conditions of 2000 rpm×10 minutes to obtain a supernatant liquid.

Next, 1 mL of TISAB (Total Ionic Strength Adjustment Buffer was adjusted to a pH of 5.5 by adding sodium hydroxide to a mixture of acetic acid, sodium chloride and sodium acid citrate) was mixed in the supernatant liquid of 9 mL obtained in each of the Example and the Comparative Example to obtain a solution. Then, the solution was stirred and then electric potential of the solution was measured.

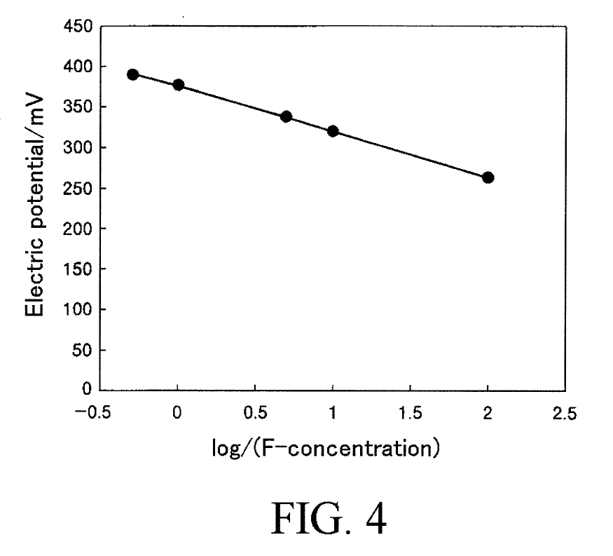

On the other hand, reference solutions having different concentrations of a fluorine ion were prepared. Then, electric potentials of the reference solutions were measured. Thereafter, the different concentrations of the fluorine ions contained in the reference solutions and the measured electric potentials were used for plotting a calibration curve. The plotted calibration curve was shown in FIG. 4.

Thereafter, a concentration of a fluorine-ion contained in the supernatant liquid was obtained by using the measured electric potential of the solution and the calibration curve.

The thus obtained concentration of the fluorine-ion contained in the supernatant liquid obtained in each of the Example and the Comparative Example was shown in Table 1.

As shown in Table 1, the concentrations of the fluorine ions separated from the fluoroapatite sintered particles 1 and 2 obtained in the Example were not great different from the concentrations of the fluorine ion separated from fluoroapatite sintered particles 1 and 2 obtained in the Comparative Example. However, there was a tendency that the concentration of the fluorine ion separated from the fluoroapatite dried particles obtained in the Example was lower than the concentration of the fluorine ion separated from the fluoroapatite dried particles obtained in the Comparative Example.

TABLE 1

| | | Rate of substitution of | | | | | |
|---|---|---|---|---|---|---|---|
| | | hydroxyl groups of | | | Specific | Particle | Free |
| | | hydroxyapatite primary | Kind of | Sintering | surface | breaking | fluorine-ion |
| | | particles by fluorine | fluoroapatite | temperature of | area | strength | concentration |
| | Fluorine source | atoms | particles | dried particles | [m²/g] | [MPa] | [ppm] |
| Ex. 1 | Hydrogen | 100% | Dried | not sintering | 39.82 | 5.32 | 5.53 |
| | fluoride | | particles | | | | |
| | | | Sintered | 400° C. | 26.40 | 13.97 | 5.30 |
| | | | particles 1 | | | | |
| | | | Sintered | 700° C. | — | — | 1.05 |
| | | | particles 2 | | | | |
| Com. Ex. | Ammonium | 70% | Dried | not sintering | 42.09 | 4.69 | 301 |
| | hydrogen | | particles | | | | |
| | fluoride | | Sintered | 400° C. | 34.43 | 14.38 | 1.83 |
| | | | particles 1 | | | | |
| | | | Sintered | 700° C. | — | — | 1.15 |
| | | | particles 2 | | | | |
| Ref. Ex. | — | 0% | Dried | not sintering | 90.03 | 2.47 | — |
| | | | particles | | | | |
| | | | Sintered | 400° C. | 40.05 | 3.43 | — |
| | | | particles 1 | | | | |

2-5. Evaluation of Change in Protein Adsorption Ability

Each of the fluoroapatite sintered particles 1 obtained in the Example and the Comparative Example was filled into a filling space of a column (“LCI-1116WF −4.0×100−2 PL-PEEK”, Sugiyama Shoji Co., Ltd., inner diameter: 4.0 mm, length: 100 mm) so that the filling space of the column was almost fully filled with the fluoroapatite sintered particles 1. In this way, columns filled with the fluoroapatite sintered particles 1 of the Example and the Comparative Example were prepared, respectively.

It is to be noted that the capacity of the filling space of each column was 1.256 mL.

Then, 125.6 mL of a 400 mM sodium phosphate buffer (at pH 5 and 25° C.) was allowed to pass through each of the columns at a flow rate of 1.0 mL/min.

Then, a sample was prepared by dissolving myoglobin, ovalbumin, α-chymotrypsinogen A, and cytochrome C in a 1 mM sodium phosphate buffer (pH 6.8) so that concentrations thereof became 5 mg/mL, 10 mg/mL, 5 mg/mL, and 5 mg/mL, respectively, and 50 μl of the sample was supplied into each of the filling spaces of the columns.

Then, a phosphate buffer (pH 6.8) was supplied into each of the filling spaces of the columns. Then, the supplied phosphate buffer was flowed at a flow rate of 1 mL/min for 22 minutes, and then the each absorbance of myoglobin, ovalbumin, α-chymotrypsinogen A, and cytochrome C contained in the phosphate buffer discharged from the column was measured at a wavelength of 280 nm.

It is to be noted that the phosphate buffer (pH 6.8) was supplied into each of the columns in such a manner that a mixing ratio of a 400 mM phosphate buffer to a 10 mM phosphate buffer was increased from 0 to 75% during a period of time from the 1st minute to the 16th minute and was then kept at 100% for 5 minutes after the 16th minute.

It is to be noted that also before the sodium phosphate buffer having a pH of 5 was allowed to pass through the columns as described above, separation of myoglobin, ovalbumin, α-chymotrypsinogen A, and cytochrome C had been carried out in each of the columns under the same conditions as described above.

A change in a protein (i.e. myoglobin, ovalbumin, α-chymotrypsinogen A, and cytochrome C) separation characteristics of the fluoroapatite sintered particles before and after the supplying of the sodium phosphate buffer having the pH of 5 into the filling space of each of the columns was examined, respectively.

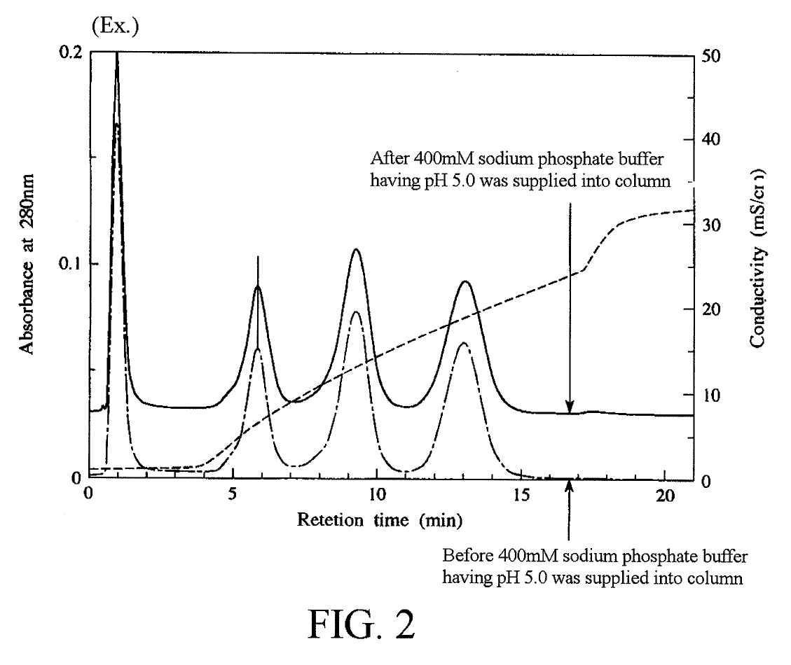

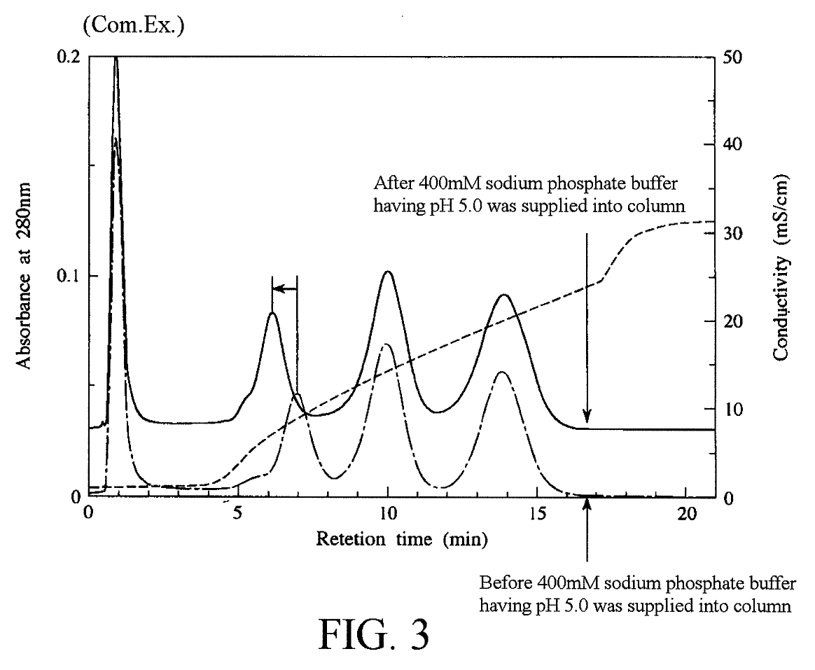

As a result, no change in the protein separation characteristics was found in the case where the column filled with the fluoroapatite sintered particles 1 of the Example was used as shown in FIG. 2 and FIG. 3.

On the other hand, in the case where the column filled with the fluoroapatite sintered particles 1 of the Comparative Example was used, myoglobin tended to be eluted earlier when protein separation was carried out after the sodium phosphate buffer having the pH of 5 was supplied into the filling space of the column.

This results from a cause that a large amount of fluorine atoms are separated from the fluoroapatite sintered particles 1 obtained in the Comparative Example. In other words, this results from a cause that acid resistance of the fluoroapatite sintered particles 1 obtained in the Comparative Example is lowered, thereby eluting calcium from the fluoroapatite sintered particles 1. As a result, it became difficult to adsorb myoglobin, which is a neutral protein adsorbable to a Ca site, to the fluoroapatite sintered particles 1.

2-6. Conclusion

As described above, the specific surface areas and the particle breaking strengths of the fluoroapatite dried particles and the fluoroapatite sintered particles 1 obtained in the Example were approximately the same as those of the fluoroapatite dried particles and the fluoroapatite sintered particles 1 obtained in the Comparative Example. Further, crystallinities of the fluoroapatite dried particles and the fluoroapatite sintered particles 1 obtained in the Example were higher than that of the fluoroapatite dried particles and the fluoroapatite sintered particles 1 obtained in the Comparative Example. Therefore, in the Example, separation of the fluorine atoms was prevented appropriately.

When the fluoroapatite dried particles of which average particle size was 40 μm±5 μm were classified to obtain 2 g thereof, the 2 g of the classified fluoroapatite dried particles was mixed with pure water of 20 mL to obtain a mixture, and the classified fluoroapatite dried particles were allowed to settle down in the mixture to obtain a supernatant liquid containing a fluorine ion, a concentration of the fluorine ion (free fluorine ion) contained in the supernatant liquid was 12 ppm or less. In this way, it was found that the fluoroapatite dried particles and the fluoroapatite sintered particles obtained by sintering the fluoroapatite dried particles, from which the fluorine atoms (fluorine ion) of a concentration of 12 ppm or less were separated to the supernatant liquid had improved acid resistance.

Further, it is also to be understood that the present disclosure relates to subject matter contained in Japanese Patent Application No. 2007-257674 (filed on Oct. 1, 2007) which is expressly incorporated herein by reference in its entireties.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. Fluoroapatite dried particles which are obtained by reacting hydroxyapatite primary particles having hydroxyl groups and hydrogen fluoride molecules having fluorine atoms so that at least one of the hydroxyl groups of the hydroxyapatite primary particles are substituted by the fluorine atoms of the hydrogen fluoride molecules,
wherein when the fluoroapatite dried particles of which average particle size is 40 μm±5 μm are classified to obtain 2 g thereof, the 2 g of the classified fluoroapatite dried particles is mixed with 20 mL of pure water to obtain a mixture, and the classified fluoroapatite dried particles are allowed to settle down in the mixture to obtain a supernatant liquid in which a fluorine ion may be contained, a concentration of the fluorine ion contained in the supernatant liquid is 12 ppm or less.

2. The fluoroapatite dried particles as claimed in claim 1, wherein the settling of the classified fluoroapatite dried particles in the mixture is carried out by subjecting the mixture to a stirring treatment and an ultrasonic treatment, and then subjecting the mixture to a centrifugation treatment to obtain the supernatant liquid.

3. The fluoroapatite dried particles as claimed in claim 1, wherein a specific surface area of the fluoroapatite dried particles is 30 m²/g or larger.

4. The fluoroapatite dried particles as claimed in claim 1, wherein an average particle size of the fluoroapatite dried particles is in the range of 30 to 50 μm.

5. The fluoroapatite dried particles as claimed in claim 1, wherein the hydrogen fluoride molecules are contained in a hydrogen fluoride-containing solution, the hydroxyapatite primary particles are contained in a slurry, and the hydrogen fluoride-containing solution is mixed with the slurry to obtain a dispersion liquid, wherein the reacting the hydroxyapatite primary particles and the hydrogen fluoride molecules is carried out in the dispersion liquid.

6. The fluoroapatite dried particles as claimed in claim 5, wherein a pH of the dispersion liquid is in the range of 2.5 to 5.0.

7. The fluoroapatite dried particles as claimed in claim 5, wherein the hydroxyapatite primary particles are synthesized from a calcium compound and a phosphate compound by using a wet synthesis method, wherein at least one of the calcium compound and the phosphate compound is contained in a solution to provide the slurry in the wet synthesis method.

8. An adsorption apparatus provided with an adsorbent, wherein the adsorbent is comprised of the fluoroapatite dried particles defined in claim 1 or fluoroapatite sintered particles obtained by sintering the fluoroapatite dried particles.
